(19) United States
(12) Patent Application Publication
(10) Pub. No.: US 2002/0197443 A1
(43) Pub. Date: Dec. 26, 2002

(54) Process for preparing carpets having polyurethane backings obtained from polyurethane latex formulations

(76) Inventors: Alan K. Schrock, Lake Jackson, TX (US); Wayne R. Willkomm, Lake Jackson, TX (US); Franklin E. Parks, Jones Creek, TX (US); Douglas R. Moore, Clute, TX (US); Rick L. Tabor, Missouri City, TX (US); James J. Jakubowski, Midland, MI (US); Regina A. Johnson, Lake Jackson, TX (US); John M. Kernstock, Bay City, MI (US); James E. Pate III, Sanford, MI (US); Michael A. Norton, Dalton, GA (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/230,511

(22) Filed: Aug. 28, 2002

Related U.S. Application Data
(62) Division of application No. 09/551,900, filed on Apr. 19, 2000, now abandoned.
(60) Provisional application No. 60/041,255, filed on Mar. 17, 1997.

(51) Int. Cl. B32B 3/02; D04H 11/00

(52) U.S. Cl. 428/95; 428/85; 428/96

(57) ABSTRACT

The present invention is a polyurethane backed carpet having a backing prepared by application of an aqueous dispersion of a polyurethane or a polyurethane-forming material to the back of a carpet substrate. The present invention can eliminate the need to prepare a polyurethane backing from its monomeric components at the carpet manufacturing site. The polyurethane backed carpet of the present invention can be efficiently prepared by a continuous process.

### BACKGROUND OF THE INVENTION

This application claims the benefit of U.S. Provisional Application No. 60/041,255, filed Mar. 17, 1997.

The present invention relates to polyurethane backed carpets. The present invention particularly relates to polyurethane backed carpets and to a process used in making same from polyurethane latex compositions.

In the manufacture of tufted carpets, a secondary adhesive backing is required to anchor the carpet tufts to the primary backing of the carpet. Carpets having an attached polyurethane backing can provide superior performance in the areas of tuft bind, hand, delamination, resistance to property loss in the presence of water, and wear resistance. Carpets and other substrates having attached polyurethane foam layers as backing are described in U.S. Pat. Nos.: 3,755,212; 3,772,224; 3,821,130; 3,862,879; 4,022,941; 4,171,395; 4,278,482; 4,286,003; 4,296,159; 4,405,393; 4,483,894; 4,512,831; 4,515,646; 4,595,436; 4,611,044; 4,657,790; 4,696,849; 4,853,054; 4,853,280 and, 5,104,693, for example. Carpets having polyurethane backings tend to be more expensive than carpets that incorporate other types of backings due to the raw material costs in producing a polyurethane backing. For this reason, polyurethanes are typically used in higher grade carpets, and are typically not used in low and intermediate grade carpets.

Current practice in the carpet manufacturing industry requires that polyurethane carpet backings be prepared from an isocyanate formulation (A-side formulation) and a polyol formulation (B-side formulation) at the carpet manufacturing site. This is sometimes referred to as “A+B chemistry”. Preparing a polyurethane by A+B chemistry can result in unpredictable loss of production and inefficiency due to problems that can occur in carrying out the reaction at the manufacturing site.

Styrene-butadiene (SB) latexes are well known. SB latexes for use in carpet are described, for example, in P. L. Fitzgerald, “Integral Latex Foam Carpet Cushioning”, J. Coat. Fab. 1977, Vol. 7 (pp.107-120); and in R. P. Brentin, “Latex Coating Systems for Carpet Backing”, J. Coat. Fab. 1982, Vol. 12 (pp. 82-91). SB latexes are used extensively as anchor coatings in carpets. SB latexes can provide good tuft bind, with a relatively high degree of stiffness, at a relatively low investment cost. SB latexes can provide relatively low stiffness with reduced tuftbind properties at a relatively low investment cost, as well. SB latexes also can provide flexibility in production costs owing to the ability to include low to high concentrations of filler component in a low viscosity latex. However, SB latexes with filler may not meet the rigorous standards set for intermediate grade carpets. In addition, current technology may require that a latex material be storage stable for a period of up to one year. For this reason, SB latexes having solids content of greater than 55% are not typical of commercially available SB latexes because such latexes generally are not storage stable.

Polyurethane/urea (PU) latexes are known and are used, for example, as coatings for wood finishing; glass fiber sizing; textiles; adhesives; and automotive topcoats and primers. Automotive topcoats, adhesives for food packaging, and textiles primarily utilize aliphatic isocyanates. Wood finishing and topcoats primarily use aromatic isocyanates. PU latexes can be prepared by polymerization, in an organic solvent, of reactants—such as isocyanates and polyols, for example—useful in preparing polyurethanes, followed by dispersion of the resulting solution in water, and optionally followed by removal of organic solvent. PU latexes can be prepared by various processes, including, for example, those described in: U.S. Pat. Nos. 4,857,565; 4,742,095; 4,879,322; 3,437,624; 5,037,864; 5,221,710; 4,237,264; and, 4,092,286. Elimination of the use of volatile organic solvents from the process can be desirable from both a cost saving standpoint and an environmental perspective.

It would be desirable to prepare polyurethane backed carpets according to a process wherein a high performance polyurethane backing can be applied to any grade of carpet in a cost-effective process. It would also be desirable to eliminate the need to prepare a polyurethane carpet backing using A+B chemistry at a carpet manufacturing site. Further, it would be desirable to prepare a polyurethane backed carpet by a continuous process wherein a polyurethane latex can be applied to a carpet without the additional step of removing a volatile organic solvent.

### SUMMARY OF THE INVENTION

In one aspect, the present invention is a backed carpet having as a backing at least one coat of polymer that is obtained from a dispersion of a polyurethane or polyurethane-forming material in water.

In another aspect, the present invention is a process for preparing a backed carpet comprising the steps: (1) dispersing a polyurethane prepolymer in water to obtain an aqueous dispersion of prepolymer; (2) applying the aqueous dispersion to the back of a carpet substrate; (3) removing the water from the aqueous dispersion to obtain a backed carpet.

### DESCRIPTION OF THE PREFERRED EMBODIMENTS

The carpet of the present invention comprises a polyurethane carpet backing that is obtained by application of a polyurethane latex composition to the back of a carpet substrate. In the present invention, polyurethane can refer to either a polyurethane compound, a polyurea compound, or both. Polyurethanes can be obtained by the reaction of a polyol with an polyisocyanate. Polyureas can be obtained by the reaction of amines with polyisocyanates. A polyurethane or polyurea can contain both urea and urethane functionality, depending on what is included in the A and/or B-side formulations. For the purposes of the present application, no further distinction will be made herein between the polymeric materials. The term “polyurethane” will be used generically to describe either, or both, polyurethane polymers and polyurea polymers—separately or in combination. As used in the present application, the terms “latex” and “aqueous dispersion” are used interchangeably. A PU latex composition useful in the practice of the present invention includes water, and either: a polyurethane; a mixture capable of forming a polyurethane; or a mixture of both. A PU latex as described herein can optionally include: chain extenders; surfactants; fillers; dispersants; foam stabilizers; thickeners; fire retardants, and/or other optional materials that can be useful in polyurethane formulations.

In the practice of the present invention, a PU latex is an aqueous dispersion of a polyurethane and/or polyurethane-forming materials. Polyurethane-forming materials as used in the present invention are materials which are capable of forming polyurethane polymers. Polyurethane-forming materials include, for example, polyurethane prepolymers. Prepolymers useful in the practice of the present invention are prepared by the reaction of active hydrogen compounds with any amount of isocyanate in excess material relative to active hydrogen material. The isocyanate functionality can be present in an amount of from about 0.2 wt % to about 40 wt %. A suitable prepolymer can have a molecular weight in the range of from about 100 to about 10,000. Prepolymers useful in the practice of the present invention should be substantially liquid under the conditions of dispersal.

Active hydrogen compounds can be described as compounds having functional groups that contain at least one hydrogen atom bonded directly to an electronegative atom such as nitrogen, oxygen or sulfur. Suitable active hydrogen compounds can be polyols of molecular weight of less than about 6000.

Other latexes can be used in combination with the polyurethane latexes of the present invention to prepare carpet backings of the present invention. Suitable latexes useful for blending with polyurethane latexes of the present invention include: styrene-butadiene latexes; styrene-butadiene-vinylidene chloride latexes; styrene-alkyl acrylate latexes; or acrylic latexes; like compunds and mixtures thereof.

The present invention optionally includes a chain extender. A chain extender is used herein to build the molecular weight of the polyurethane prepolymer by reaction of the chain extender with the isocyanate functionality in the polyurethane prepolymer, i.e., chain extend the polyurethane prepolymer. A suitable chain extender is typically a low equivalent weight active hydrogen containing compound having about 2 or more active hydrogen groups per molecule. The active hydrogen groups can be hydroxyl, mercaptyl, or amino groups. An amine chain extender can be blocked, encapsulated, or otherwise rendered less reactive. Other materials, particularly water, can function to extend chain length and so are chain extenders for purposes of the present invention. Polyamines are preferred chain extenders. It is particularly preferred that the chain extender be selected from the group consisting of amine terminated polyethers such as, for example, Jeffamine D-400 from Huntsman Chemical Company, amino ethyl piperazine, 2-methyl piperazine, 1,5-diamino-3-methyl-pentane, isophorone diamine, ethylene diamine, diethylene triamine, triethylene tetramine, triethylene pentamine, ethanol amine, lysine in any of its stereoisomeric forms and salts thereof, hexane diamine, hydrazine and piperazine. In the practice of the present invention, the chain extender is often used as a solution of chain extender in water.

In preparing a polyurethane backing of the present invention, small amounts of chain extender can be advantageously used. Generally, the chain extender is employed at a level sufficient to react with from about zero (0) to about 100 percent of the isocyanate functionality present in the prepolymer, based on one equivalent of isocyanate reacting with one equivalent of chain extender. It can be desirable, under certain conditions, to allow water to act as a chain extender and react with some or all of the isocyanate functionality present. A catalyst may optionally be used to promote the reaction between a chain extender and an isocyanate.

Suitable catalysts for use in the present invention include tertiary amines, and organometallic compounds, like compounds and mixtures thereof. For example, suitable catalysts include di-n-butyl tin bis(mercaptoacetic acid isooctyl ester), dimethyltin dilaurate, dibutyltin dilaurate, dibutyltin sulfide, stannous octoate, lead octoate, ferric acetylacetonate, bismuth carboxylates, triethylenediamine, N-methyl morpholine, like compounds and mixtures thereof. An amount of catalyst is advantageously employed such that a relatively rapid cure to a tack-free state can be obtained. If an organometallic catalyst is employed, such a cure can be obtained using from about 0.01 to about 0.5 parts per 100 parts of the polyurethane-forming composition, by weight. If a tertiary amine catalyst is employed, the catalyst preferably provides a suitable cure using from about 0.01 to about 3 parts of tertiary amine catalyst per 100 parts of the polyurethane-forming composition, by weight. Both an amine type catalyst and an organometallic catalyst can be employed in combination.

The present invention optionally includes a filler material. The filler material can include conventional fillers such as milled glass, calcium carbonate, ATH, talc, bentonite, antimony trioxide, kaolin, fly ash, or other known fillers. In the practice of the present invention, a suitable filler loading in a PU latex can be from about 100 to about 1000 parts of filler per 100 parts of polyurethane. Preferably, filler can be loaded in an amount of at least about 200 pph, more preferably at least about 300 pph, most preferably at least about 400 pph.

The present invention also optionally includes a filler wetting agent. A filler wetting agent generally performs the function of compatiblizing the filler and the polyurethane-forming composition. Useful wetting agents include phosphate salts such as sodium hexametaphosphate. A filler wetting agent can be included in a polyurethane-forming composition of the present invention at a concentration of at least about 0.5 parts per 100 parts of filler, by weight.

The present invention optionally includes thickeners. Thickeners are useful in the present invention for increasing the viscosity of low viscosity PU latexes. Thickeners suitable for use in the practice of the present invention are any that are known in the art of preparing polyurethane latexes. For example, suitable thickeners include Alcogum™ VEP-II (trade designation of Alco Chemical Corporation) and Paragum™ 231 (trade designation of Para-Chem Southern, Inc.). Thickeners can be used in any amount necessary to obtain a dispersion of desired viscosity.

The present invention can include other optional components. For example, a polyurethane-forming composition of the present invention can include surfactants, blowing agents or frothing agents, fire retardant, pigments, antistatic agents, reinforcing fibers, antioxidants, preservatives, acid scavengers, and the like. Examples of suitable blowing agents include gases such as air carbon dioxide, nitrogen, argon, helium, and the like; liquids such as water, volatile halogenated alkanes such as the various chlorfluoromethanes and chlorfluoroethanes; azo-blowing agents such as azobis(formamide). Preferred in the practice of this invention is the use of a gas as a blowing or frothing agent. Particularly preferable is the use of air as a blowing or frothing agent. A frothing agent can differ from a blowing agent in that frothing agents are typically introduced by mechanical introduction of a gas into a liquid to form a froth.

Surfactants can be desirable in the present invention. Surfactants useful herein can be cationic surfactants, anionic surfactants, or a non-ionic surfactants. Examples of anionic surfactants include sulfonates, carboxylates, and phosphates. Examples of cationic surfactants include quaternary amines. Examples of non-ionic surfactants include block copolymers containing ethylene oxide and silicone surfactants. Surfactants useful in the practice of the present invention can be either external surfactants or internal surfactants. External surfactants are surfactants which do not become chemically reacted into the polymer during latex preparation. Internal surfactants are surfactants which do become chemically reacted into the polymer during latex preparation. A surfactant can be included in a formulation of the present invention in an amount ranging from about 0.01 to about 20 parts per 100 parts by weight of polyurethane component.

Generally, any method known to one skilled in the art of preparing polyurethane latexes can be used in the practice of the present invention to prepare a PU latex material suitable for preparing a carpet of the present invention. A suitable storage-stable PU latex as defined herein is any PU latex having a mean particle size of less than about 5 microns. A PU latex that is not storage-stable can have a mean particle size of greater than 5 microns. For example, a suitable dispersion can be prepared by mixing a polyurethane prepolymer with water and dispersing the prepolymer in the water using a commercial blender. Alternatively, a suitable dispersion can be prepared by feeding a prepolymer into a static mixing device along with water, and dispersing the water and prepolymer in the static mixer. Continuous methods for preparing aqueous dispersions of polyurethane are known and can be used in the practice of the present invention. For example, U.S. Pat. Nos.: 4,857,565; 4,742,095; 4,879,322; 3,437,624; 5,037,864; 5,221,710; 4,237,264; and 4,092,286 all describe continuous processes useful for obtaining polyurethane latexes. In addition, a polyurethane latex having a high internal phase ratio can be prepared by a continuous process as described in U.S. Pat. No. 5,539,021, incorporated herein by reference.

In the practice of the present invention, any of the steps used in preparing a polyurethane carpet backing can be carried out in a continuous manner. For example, in a first step the prepolymer can be prepared from a suitable active hydrogen containing compound in a continuous manner; the prepolymer can be fed, as it is obtained in the first step, into a mixing device with water to obtain an aqueous dispersion; the aqueous dispersion can be applied to a carpet substrate in a continuous manner to obtain a polyurethane backed carpet.

A polyurethane dispersion of the present invention can be stored for later application to the back of a carpet. Storage for this purpose requires that the dispersion be storage-stable. Alternatively, the polyurethane latex can be applied in a continuous manner to the back of a carpet substrate. That is, the dispersion can be applied to the back of a carpet as the dispersion is obtained according to the practice of the present invention. Polyurethane latexes applied to carpet in a continuous manner are not required to be storage-stable, and can have higher solids content and/or larger mean particle size than typical storage-stable polyurethane latex formulations.

In preparing polymer backed carpets according to the present invention, a polyurethane-forming composition is applied as a layer of preferably uniform thickness onto one surface of a carpet substrate. PU latexes of the present invention can be applied as a precoat, laminate coat or applied as a foam coat. Polyurethane precoats, laminate coats, and foam coats can be prepared by methods known in the art. Precoats, laminate coats and foam coats prepared from latexes are described in P. L. Fitzgerald, “Integral Latex Foam Carpet Cushioning”, J. Coat. Fab. 1977, Vol. 7 (pp.107-120), and in R. P. Brentin, “Latex Coating Systems for Carpet Backing”, J. Coat. Fab. 1982, Vol. 12 (pp. 82-91), for example. In preparing a frothed polyurethane backing (frothing), it is preferred to mix all components and then blend a gas into the mixture, using equipment such as an Oakes or Firestone foamer.

The polyurethane-forming composition can be applied to one surface of a carpet substrate before it cures to a tack-free state. Alternatively, a PU latex containing no unreacted isocyanate functionality can be applied, thereby removing the need to cure the polymer. Typically the polyurethane-forming composition is applied to the surface attached to a primary backing. The composition may be applied to the carpet substrate using equipment such as a doctor knife, air knife, or extruder to apply and gauge the layer. Alternatively, the composition may be formed into a layer on a moving belt or other suitable apparatus and dehydrated and/or partially cured, then married to the carpet substrate using equipment such as a double belt (also known as double band) laminator or a moving belt with an applied foam cushion. The amount of polyurethane-forming composition used can vary widely, from about 5 to about 500 ounces per square yard, depending on the characteristics of the textile. After the layer is applied and gauged, water is removed from the dispersion and the layer can be cured using heat from any suitable heat source such as an infrared oven, a convection oven, or heating plates.

The following examples are provided to illustrate the present invention. The examples are not intended to limit the scope of the present invention and should not be so interpreted. The prepolymer (Prepolymer A) was prepared as follows:

Prepolymer A

633.5 g (0.634 eq.) of a 12.5% ethylene oxide capped polypropylene oxide diol with an equivalent weight of 1000 g/eq, 333 g (2.664 eq.) of a mixture of 50 percent 2,4′-MDI and 50 percent 4,4′-MDI, 13.5 g (0.255 eq.) of diethylene glycol, and 20 g (0.021 eq) of polyethylene oxide monol having a molecular weight of 950 are mixed with heating to 70° C. in a glass vessel for 15 hours.

### EXAMPLES

### Example 1

The following processes are conducted at ambient temperature (19° C.). Prepolymer A is fed continuously at rate of 32.1 g/minute through a first arm fitted to a first T. DeSULF™ DBS-60T surfactant (a 60 percent aqueous solution of triethanolamine dodecylbenzene sulfonate, a Trademark of DeForest Enterprises, Inc.) is fed at a rate of 1.61 g/minute through a first arm of a second T, and merged with a water stream flowing at a rate of 5.5 g/minute through the second arm of the second T. The prepolymer stream and the water/surfactant stream are merged at the first T, passed through a static mixer, and fed to the input port of a IKA-SD 41 SUPER-DISPAX™ dispersing instrument (a Trademark of IKA-WORKS, Inc.), a rotor/stator device operated at 1200 rpm.

The ratios of feeds into the dispersing instrument are 81.9 percent prepolymer, 4.1 percent surfactant solution, and 14.0 percent water. The HIPR emulsion formed in the dispersing instrument has a volume average particle size of 0.265 micron and a polydispersity of 3.1, as measured by a Coulter LS130 particle size analyzer.

Chain extension is accomplished in a LIGHTNIN™ model 0.025 LB in-line blender (a Trademark of GREEY/LIGHTNIN). The HIPR emulsion from the dispersing instrument is fed into a first arm attached to a third T and merged with an aqueous stream fed through a second arm of the third T at the rate of 5.1 g/minute. The output of the combined streams is fed into one arm of a fourth T, which is attached to the input of the in-line blender. Concurrently, a 10 percent aqueous piperazine solution is pumped at a constant rate of 18.0 g/minute (0.75 equivalents, based on the isocyanate groups of the prepolymer) through the other arm of the fourth T. The two streams are mixed in the in-line blender operating at 1500 rpm. The product is collected and allowed to stand overnight to allow water to react with the remaining isocyanate groups. The resulting stable polyurethane latex has a solids content of 56.0 percent by weight, a volume average particle size of 0.256 micron, and a polydispersity of 3.5, as measured by a Coulter LS 230 particle size analyzer.

The latex is compounded by mixing 178.6 parts latex (100 parts latexes solids) with 200 parts calcium carbonate filler. Stirring is begun with latex alone, then the filler is added as quickly as it is dispersed in the liquid. Paragum™ 241 thickener (a Trademark of Para-Chem Southern, Inc.) is added until the a viscosity of 9300 cPs is reached. The carpet for testing is a nylon level loop style with a greige weight of 23 oz/yd². Compound is applied to the back of this carpet at a coating weight of 35 oz/yd², followed by a polypropylene scrim, 3.3 oz/yd², as a secondary backing. The carpet is dried at 132° C. for 12 minutes, then allowed to equilibrate overnight before testing.

The carpet of Example 1 has a tuftbind of 21.5 pounds. Tuftbind values are obtained according to ASTM D1335. The carpet of Example 1 has a dry delamination of 10.1 pounds/in. and a re-wet delamination of 5.0 pounds/in. The delamination is the strength required to remove the secondary polypropylene scrim from the fabricated carpet. It is determined by cutting a 3 inch by 9 inch strip of carpet, and peeling the secondary scrim from the main portion of the carpet while measuring the force required. The rewet delamination is determined in the same manner, except that the carpet specimen is soaked for one minute in water, and blotted dry prior to testing. The carpet of Example 1 has a hand punch of 17.4 pounds. The hand punch is measured as the force required to push a 9 inch by 9 inch piece of carpet 0.5 inches into a 5.5 inch inner diameter cylinder at a rate of 12.0 inches per minute, using a 2.25 inch outer diameter solid cylinder attached to a load cell.

### Example 2

The procedure used to prepare the latex from Example 1 is repeated, with the following exceptions. The surfactant is DeSULF™ TLS-40 surfactant (a 40 percent aqueous solution of triethanolamine lauryl sulfate, a trademark of DeForest Enterprises, Inc.) and the flow rates are: prepolymer, 32.0 g/minute; surfactant, 2.4 g/minute; and water, 3.5 g/minute. The ratios of the components that are fed into the disperser were prepolymer, 84.4 percent; surfactant solution, 6.3 percent; and water, 9.2 percent. The HIPR emulsion has a volume average particle size of 0.182 micron and a polydispersity of 1.6, as measured by a Coulter LS130 particle size analyzer.

The aqueous stream used to dilute the HIPR emulsion is flowed at a rate of 4.6 g/minute, and the piperazine solution is pumped at a rate of 17.9 g/minute. The final poly(urethane/urea) latex has a solids content of 53.9 percent by weight, and a volume average particle size of 0.365 micron.

The latex is compounded as in Example 1. Paragum 241 thickener (supplied by Para-Chem Southern, Inc.) is added until a viscosity of between 8,000 and 10,000 cPs was reached. Compound was applied to the back of the same carpet as in Example 1 at a coating weight of 35.7 oz/yd², followed by a polypropylene scrim, 3.3 oz/yd², as a secondary backing. The carpet is dried at 132° C. for 12 minutes, then allowed to equilibrate overnight before testing. This carpet had a tuftbind of 21.1 pounds, a hand punch of 17.1 pounds, a dry delamination of 9.9 pounds/in. and a re-wet delamination of 7.3 pounds/in.

### Comparative Example 3

As a comparison, a standard, carpet grade styrene-butadiene latex (53.3% solids content) is compounded with calcium carbonate and thickener and applied as a carpet backing as in Example 1. The resulting carpet has a coating weight of 34.1 oz./s.yd., a tuftbind of 16.2 pounds, a delamination of 9.8 pounds/in, a hand punch of 27.0 pounds and a re-wet delamination of 6.6 pounds/in.

What is claimed is:

1. A backed carpet having as a backing at least one coat of polymer that is obtained from a dispersion of a polyurethane or polyurethane-forming material in water.

2. The carpet of claim 1 wherein the dispersion comprises: a polyurethane prepolymer; water; and a surfactant.

3. The carpet of claim 2 wherein the dispersion additionally comprises a chain extender.

4. The carpet of claim 1 wherein the polymer backing is a precoat.

5. The carpet of claim 4 wherein the polymer backing is a precoat, laminate coat, or a combination thereof.

6. The carpet of claim 5 wherein the laminate coat is obtained from an aqueous dispersion of polyurethane forming materials.

7. The carpet of claim 6 wherein the dispersion additionally comprises at least one filler material.

8. The carpet of claim 7 wherein the filler is calcium carbonate.

9. The carpet of claim 7 wherein the filler is fly ash.

10. The carpet of claim 7 wherein the dispersion includes a thickener.

11. The carpet of claim 10 wherein the dispersion includes dispersants or wetting agents.

12. The carpet of claim 7 wherein a secondary backing is applied.

13. The carpet of claim 12 wherein the secondary backing is a mesh or fleece prepared from: polypropylene; polyethylene terephthalate; nylon; or blends thereof.

14. The carpet of claim 4 wherein the carpet additionally comprises a foam coat.

15. The carpet of claim 14 wherein the foam coat is obtained from an aqueous dispersion of polyurethane-forming materials.

16. The carpet of claim 14 wherein the foam coat is obtained from a polyurethane-forming reactive mixture.

17. The carpet of claim 16 wherein the foam coat is obtained by frothing the polyurethane-forming reactive mixture.

18. The carpet of claim 1 wherein the dispersion comprises at least one additional latex material.

19. The carpet of claim 18 wherein the additional latex material is selected from the group consisting of: styrene-butadiene latexes; styrene-butadiene-vinylidene chloride latexes; styrene-alkyl acrylate latexes; acrylic latexes; like compounds, and mixtures thereof.
